(19) United States
(12) Patent Application Publication
(10) Pub. No.: US 2005/0234589 A1
(43) Pub. Date: Oct. 20, 2005

(54) Bill processing device

(76) Inventors: Tadashi Hatamachi, Saitama (JP); Tetsuro Kikuchi, Saitama (JP); Koji Akiba, Saitama (JP)

Correspondence Address: WELSH & KATZ, LTD, 120 S RIVERSIDE PLAZA, 22ND FLOOR, CHICAGO, IL, 60606, US

(21) Appl. No.: 10/514,222

(22) PCT Filed: May 8, 2003
(86) PCT No.: PCT/JP03/05731

§ 371 Date: Nov. 12, 2004

(30) Foreign Application Priority Data
May 15, 2002 (JP) 2002-140162

(51) Int. Cl. G06F 7/00

(52) U.S. Cl. 700/230

(57) ABSTRACT

A bill processing device capable of minimizing the possibility of entry of bills stored in a stacker into a bill transfer rout for obstructing the processing of a bill transferred next time, wherein a bill slip prevention means (9) for preventing the bill (101) in contact with a pair of guide parts (4) from slipping on the lateral thereof is disposed in the guide parts (4) allowing the bill (101) positioned on the pair of guide parts (4) into contact therewith among the bills (101) stored in the stacker (11), whereby the bills (101) stored in the stacker (11) can be prevented from entering the bill transfer route (3) by the bill slip prevention means.

### TECHNICAL FIELD

The present invention relates to a bill processing device used for vending machines, money changers, pinball dispensers, metal token dispensers and the like, and more particularly to a bill processing device provided with a stacker that accumulatively stores bills.

### BACKGROUND ART

Generally, a bill processing device for accumulatively storing bills that are deemed authentic among the inserted bills, is mounted in a main body of the devices that handle bills (including coupons and the like) such as vending machines.

FIG. 6 is a schematic sectional view illustrating the main part of a conventional bill processing device 41.

Referring to FIG. 6, the bill processing device 41 comprises a device body 2 and a stacker 11 which is disposed on the back of the device body 2.

The device body 2 is provided with a bill transferring route 3 (indicated by a dotted line in FIG. 6) which is communicated with a bill insertion inlet (not shown). An end portion 3a of the bill transferring route 3 is disposed along a direction perpendicular to the sheet surface of FIG. 6.

At the end portion 3a of the bill transferring route 3, a pair of guide parts 4 are provided in which the both edge portions on the lateral of a bill 101 are inserted into slits 4a so that the bill 101 is guided to the end of the bill transferring route 3 along a direction perpendicular to the sheet surface of FIG. 6.

Each of the guide parts 4 is constituted by a guide member 200 formed with the slit 4a, having a square U-shape cross section and extended in a direction along the end portion 3a of the bill transferring route 3, that is, in a direction perpendicular to the sheet surface of FIG. 6.

The slit 4a is formed in each of the guide parts 4 in a direction perpendicular to the sheet surface of FIG. 6. The pair of guide parts 4 is generally formed of a material such as plastic, which does not readily generate a friction when contacted to the bill 101, that is, having a low coefficient of friction, so as to facilitate the insertion of the both edge portions on the lateral of the bill 101 into the slits 4a.

FIG. 7 is a schematic reduced sectional view taken along line B-B of FIG. 6, illustrating a state that a stacker plate 13 (described later) and a stack spring 14 (described later) are removed from FIG. 6. As shown in FIG. 7, nothing is disposed on the outer circumferential surface of each of the guide parts 4.

As shown in FIG. 6, a bill moving means 5 for moving the bills 101 one at a time to the back faces of the pair of guide parts 4 is disposed on the device body 2 between the pair of slits 4a.

The bill moving means 5 comprises a pressing plate 5a which moves parallel to the back faces of the pair of guide parts 4 to push the bills 101, and a pressing plate drive means comprising a motor (not shown) for a reciprocating the pressing plate 5a.

The stacker 11 is disposed to cover the pair of guide parts 4.

Within the stacker 11 is disposed a pushing means 12 for continuously pushing the bills 101 (FIG. 9) stored in the stacker 11 toward the device body 2. The pushing means 12 comprises the stacker plate 13 for pushing the bills 101 and the stack spring 14 for continuously pushing the stacker plate 13 toward the device body 2.

In the bill processing device 41 configured as described above, when a bill 101 is inserted through the bill insertion inlet, the bill 101 is transferred downstream along the bill transferring route 3 by driving of a bill transferring means comprising a bill transferring belt (not shown) disposed in the bill transferring route 3, and judged as genuine or not by a bill identification means (not shown) which is disposed in the middle of the bill transferring route 3.

If the bill 101 is judged as counterfeit by the bill identification means, the bill transferring means is driven in reverse to return the bill 101 to the bill insertion inlet. When the bill 101 is judged as genuine, the bill transferring means continues its operation to transfer further the bill 101 downstream of the bill transferring route 3.

When the bill 101 guided downstream of the bill transferring route 3 reaches the end portion 3a of the bill transferring route 3 shown in FIG. 6, the both edge portions on the lateral of the bill 101 are inserted into the slits 4a of the pair of guide parts 4, and the bill 101 is guided along the pair of slits 4a.

When it is detected by a sensor (not shown) or the like that the bill 101 has reached a prescribed position in the respective slits 4a of the pair of guide parts 4, the bill transferring means stops, and the pressing plate drive means of the bill moving means is driven at the same time. When the pressing plate drive means is driven, the pressing plate 5a is moved parallel to the back sides (direction of the arrow C in FIG. 6) of the pair of guide parts 4.

Then, the approximate center of the bill 101 inserted into the slits 4a is pushed to the back sides of the pair of guide parts 4 by the pressing plate 5a as the pressing plate 5a moves parallel as shown in FIG. 8, so that the bill 101 is guided to move gradually to the back side of the pair of guide parts 4, namely the side of the stacker 11, and the both edge portions on the lateral of the bill 101 are gradually released from the respective slits 4a.

When the pressing plate 5a moves parallel until the both edge portions on the lateral of the bill 101 are completely released from the respective slits 4a, the pressing plate 5a moves parallel toward the device body 2 (direction of the arrow D in FIG. 8) to return to its initial position. When the pressing plate 5a returns to the initial position as shown in FIG. 9, the both edge portions on the lateral of the bill 101 are held between the stacker plate 13 and the outer circumferential surfaces of the pair of guide parts 4 by means of the stack spring 14. Thus, the bill 101 is stored in the stacker 11.

As shown in FIG. 10, when another bill 101 is guided to the end portion 3a of the bill transferring route 3 to have its both edge portions inserted into the pair of slits 4a, it is stored in the stacker 11 by the same operations as the above-described operations of storing the bill 101.

When the bills 101 are stored one after another in the stacker 11 as described above, the plural bills 101 are stacked and stored along the end portion 3a of the bill transferring route 3 as shown in FIG. 11. The both edge portions on the lateral of the plural bills 101 stacked and stored are held between the stacker plate 13 and the outer circumferential surfaces of the pair of guide parts 4.

The plural bills 101 stacked and stored are blocked from the end portion 3a of the bill transferring route 3 by the guide parts 4 that holds the bills so as to be prevented as much as possible from entering the end portion 3a of the bill transferring route 3. Therefore, a possibility that the bills 101 once stored in the stacker 11 enter the end portion 3a of the bill transferring route 3 so that another bill 101 to be transferred subsequently to the end portion 3a of the bill transferring route 3 cannot be transferred but clogs, is prevented as much as possible.

According to the above-described conventional bill processing device 41, when the bills 101 are stored in the stacker 11 as shown in FIG. 11, the bill 101, which is positioned on the side of the pair of guide parts 4 among the bills 101 stored in the stacker 11, has its both edge portions contacted with the outer circumferential surface of each of the guide parts 4. The respective guide parts 4 are generally formed of plastic having a small coefficient of friction, so that frictional force between the both edge portions of the bill 101 and the respective guide parts 4 is small. Therefore, the both edge portions of the bill 101 may slip on the outer circumferential surfaces of the respective guide parts 4 as indicated by arrows E in FIG. 12 to cause the approximate center of the bill 101 enter the end portion 3a of the bill transferring route 3. There was also a possibility that the bills 101 in the stacker 11 enter one after another the end portion 3a of the bill transferring route 3 from the respective approximate centers.

As described above, when the bills 101 once stored in the stacker 11 entered the end portion 3a of the bill transferring route 3, a bill 101 to be transferred next time to the end portion 3a of the bill transferring route 3 could not be transferred to the end portion 3a as shown in FIG. 12, and there was a possibility of causing a jam of the bill.

Specially, if the bills 101 stored in the stacker 11 included a bill in a poor condition such as a wrinkled bill, the both edge portions of the bill 101 in contact with the outer circumferential surfaces of the respective guide parts 4 was likely to slip from the outer circumferential surfaces of the respective guide parts 4 because of a bulge or the like formed all of the bills 101 stored in the stacker 11. Therefore, the bills 101 in the stacker 11 entered the end portion 3a of the bill transferring route 3 from their approximate centers, causing a jam of the bills conspicuously.

Therefore, the present invention is aimed at providing a bill processing device capable of preventing as much as possible a bill stored in the stacker from entering the bill transferring route so as to disturb the processing of a bill to be transferred next time.

### DISCLOSURE OF THE INVENTION

The bill processing device according to the present invention comprises a pair of guide parts formed with a pair of slits into which both edge portions on the lateral of a bill guided by a bill transferring route are inserted along a longitudinal direction of the bill; and a stacker that stores the bill which is inserted into the slits of the pair of guide parts and moved to back faces of the pair of the guide parts, wherein the respective guide parts are provided with bill slip prevention means at a portion thereof with which a bill which is positioned on the side of the pair of guide parts among the bills stored in the stacker is contacted, the bill slip prevention means preventing a slip of the edge portions on the lateral of the contacting bill, whereby the bills stored in the stacker are prevented from entering the bill transferring route by the bill slip prevention means.

With the above configuration, the both edge portions of the bill can be prevented as much as possible from a slip from the contacting guide parts by high frictional force produced between the contacting bill slip prevention means and both edge portions on the lateral of the bill positioned on the side of the pair of guide parts among the bills stored in the stacker, and the bill can be prevented as much as possible from entering the bill transferring route from the approximate center thereof. Further, remaining bills in the stacker can also be prevented as much as possible from entering the bill transferring route from the approximate center of each of the bills. Therefore, the bill to be transferred next time to the bill transferring route can be transferred to an end part of the bill transferring route with certainty, and a conventionally experienced jam of a bill can be prevented as much as possible.

Even if the bills stored in the stacker include a bill in poor condition such as a wrinkled bill, which makes the bills in the stacker bulky as a whole, the both edge portions on the lateral of the bill can be prevented as much as possible from a slip from the contacting guide parts by high frictional force produced between the mutually contacting bill slip prevention means and both edge portions on the lateral of the bill positioned on the side of the pair of guide parts among the bills stored in the stacker. Therefore, the bill is prevented from entering the bill transferring route from the approximate center of the bill as much as possible, and the remaining bills in the stacker can also be prevented from sequentially entering the bill transferring route from the approximate centers of the bills. Thus, the conventionally occurred jam of the bill can be prevented as much as possible.

### BRIEF DESCRIPTION OF THE DRAWINGS

FIG. 1 is a schematic sectional view of the main part of a bill processing device of a first embodiment according to the present invention, which is a schematic diagram illustrating a state that plural bills are stored in a stacker;

FIG. 2 is a schematic reduced sectional view taken along line A-A of FIG. 1 and a schematic diagram illustrating a state that the bills are removed from the stacker;

FIG. 3 is a schematic sectional view of the main part of a bill processing device of a second embodiment according to the present invention, which is a schematic diagram illustrating a state that plural bills are stored in the stacker;

FIG. 4 is a schematic broken sectional view of the main part of a bill processing device of a third embodiment according to the present invention, which is a schematic diagram illustrating a state that plural bills are stored in the stacker;

FIG. 5 is a schematic sectional view of the main part of a bill processing device illustrating another embodiment of guide parts;

FIG. 6 is a schematic sectional view of the main part of a conventional bill processing device;

FIG. 7 is a schematic reduced sectional view taken along line B-B of FIG. 6 and a schematic diagram illustrating a state that a stacker plate and a stack spring are removed;

FIG. 8 is a schematic diagram illustrating an operation of storing bills within the stacker of the bill processing device of FIG. 6;

FIG. 9 is a schematic diagram illustrating a state that a single bill is stored in the stacker of the bill processing device of FIG. 6;

FIG. 10 is a schematic diagram illustrating a state that a bill to be stored next time in the stacker is guided to an end part of a bill transferring route of the bill processing device of FIG. 9;

FIG. 11 is a schematic diagram illustrating a state that plural bills are house in the stacker of the bill processing device of FIG. 6; and

FIG. 12 is a schematic diagram illustrating a state that bills stored in the stacker of the bill processing device of FIG. 6 slip out of a pair of guide parts to enter the end part of the bill transferring route and a bill to be stored next time in the stacker is not transferred to the end part but causes a jam.

### BEST MODE FOR CARRYING OUT THE INVENTION

Embodiments of the bill processing device according to the present invention will be described in detail.

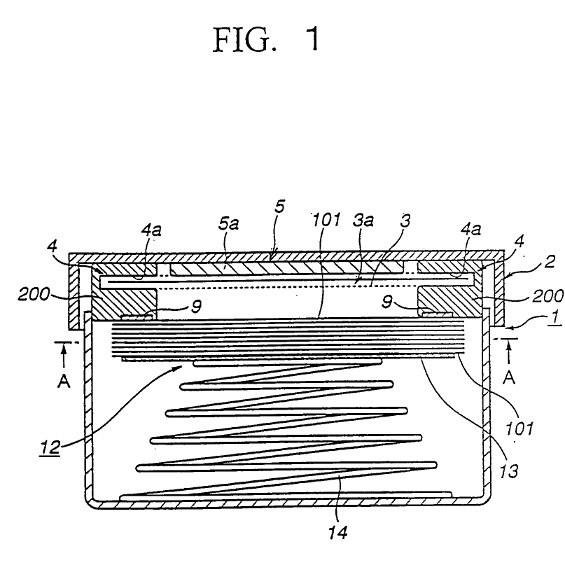

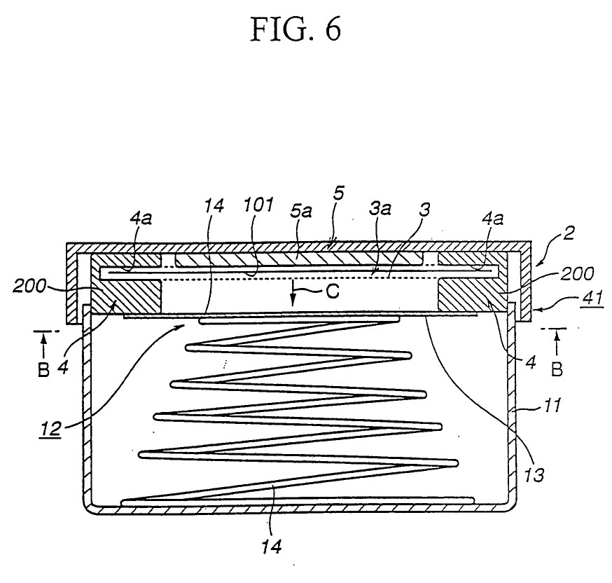

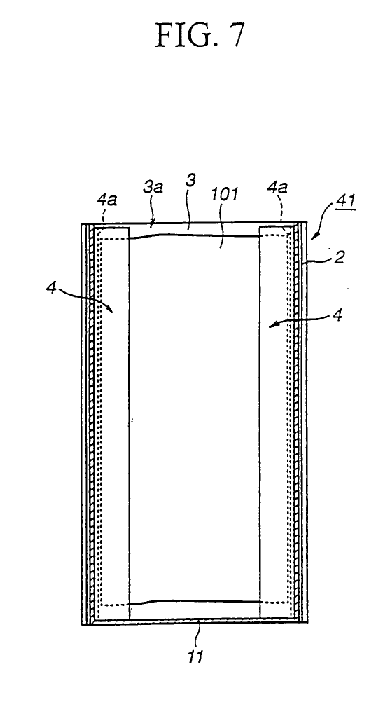

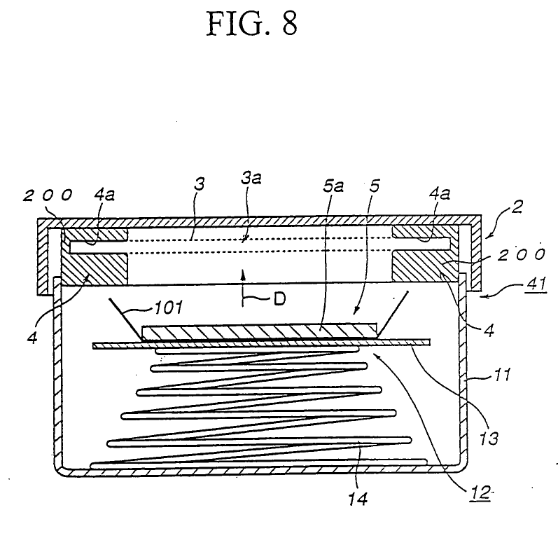

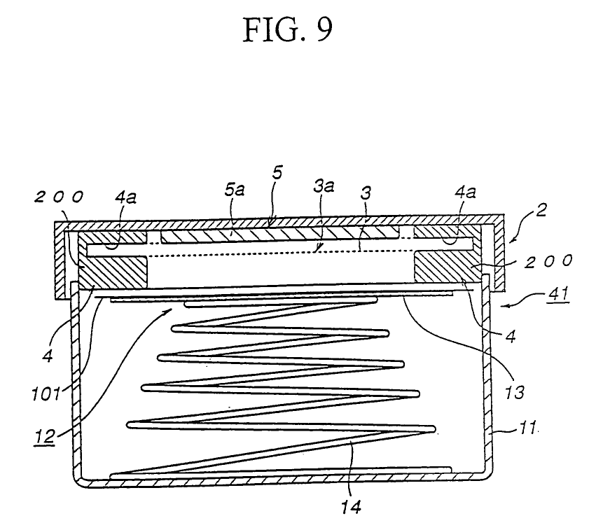

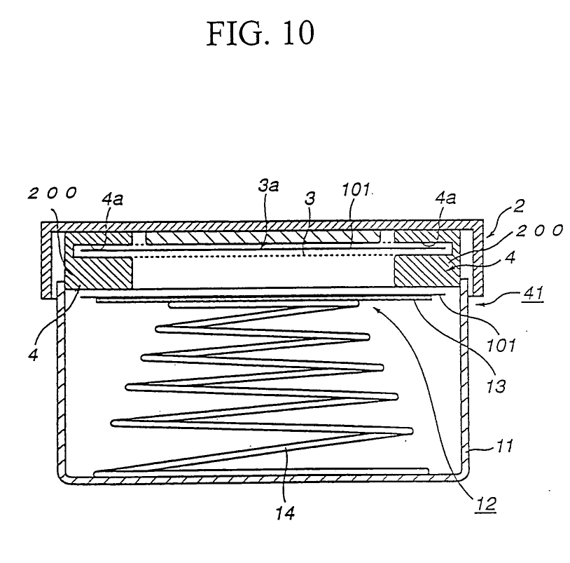

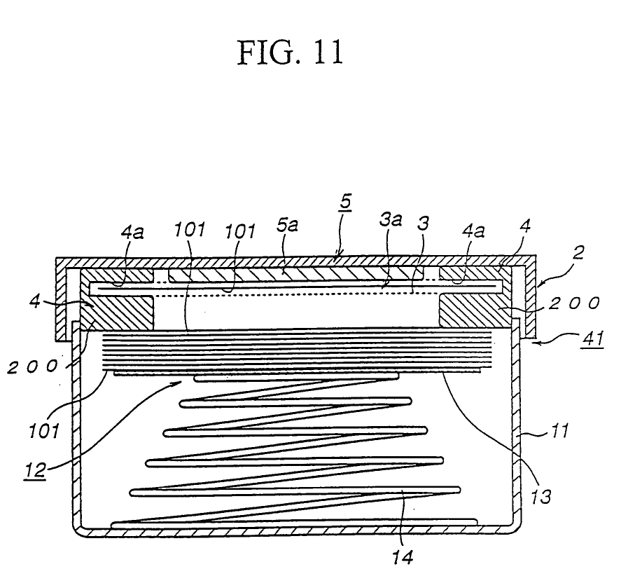

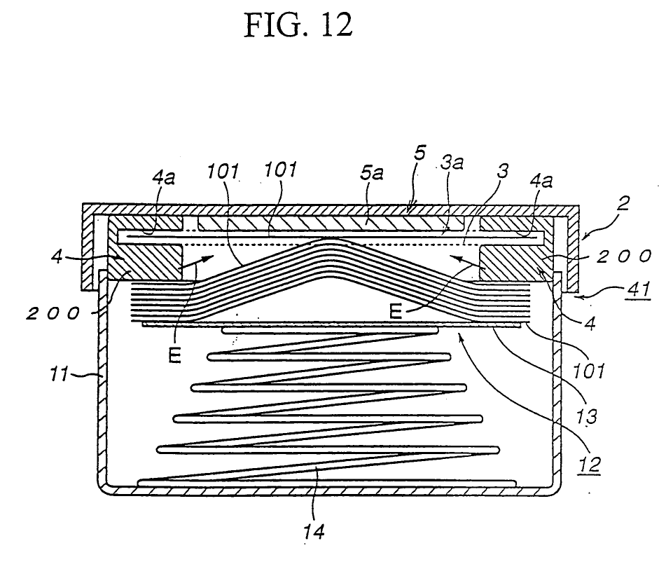

FIG. 1 is a schematic sectional view of the main part of a bill processing device 1 of a first embodiment, illustrating a state that plural bills are stored in a stacker. In FIG. 1, the same reference numerals are allotted to the same elements as those shown in FIG. 6 through FIG. 12.

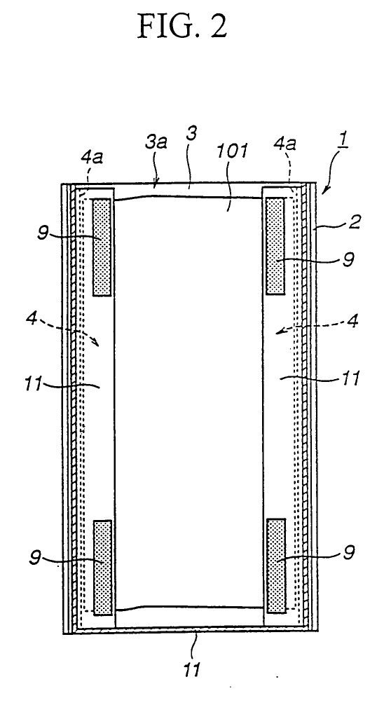

FIG. 2 is a schematic reduced sectional view taken along line A-A of FIG. 1, illustrating a state that bills 101 are removed from a stacker 11 of FIG. 1.

As shown in FIG. 1 and FIG. 2, guide members 200 of guide parts 4 with which a bill 101, which is positioned on the side of the pair of guide parts 4, among the bills 101 stored in the stacker 11 of the bill processing device 1 comes into contact, is provided with bill slip prevention means 9 which prevents a slip of the edge portions on the lateral of the contacting bill 101 to prevent the bill 101 and the remaining bills 101 in the stacker 11 from entering the end portion 3a of a bill transferring route 3 by the bill slip prevention means 9.

The bill returning-back preventing means 9 is embedded in the outer circumferential surfaces of the guide members 200 of plastic configuring the device body 3. The bill slip prevention means 9 is configured of an anti-slip member made of a material having high frictional force which is produced when contacted with the bill 101, namely a material having a high coefficient of friction. It is formed of, for example, a sheet rubber member.

The bill slip prevention means 9 are formed along the longitudinal direction of the bill 101 in the stacker 11 and disposed in the guide parts 4 with which the upper or lower part of the both edge portions on the lateral of the bill 101 positioned on the side of the guide parts 4 within the stacker 11 contacts.

In the bill processing device 1, the transfer of the bill 101 inserted through a bill insertion inlet (not shown), the return of a bill judged as counterfeit, and the storage of bills 101 judged as genuine into the stacker 11 are performed by the same operation as that of a conventional bill processing device 31.

In the bill processing device 1, when the bills 101 are stored in the stacker 11 as shown in FIG. 1, the both edge portions of the bills 101 are held between the stacker plate 13 and the outer circumferential surfaces of the pair of guide parts 4 by means of the stack spring 14. The respective guide parts 4 with which the both edge portions on the lateral of the bill 101, which is positioned on the side of the pair of guide parts 4, among the bills 101 stored in the stacker 11 are contacted are provided with an anti-slip member (a rubber member in this embodiment) as the bill slip prevention means 9 as shown in FIG. 1 and FIG. 2. Therefore, a possibility of a slip of the both edge portions of the bill 101 on the outer circumferential surfaces of the respective guide parts 4 is prevented as much as possible by high frictional force produced between the mutually contacted bill 101 and anti-slip member (a rubber member in this embodiment). Thus, a possibility of entering of the bill transferring route 3 into the end portion 3a from the approximate center of the bill 101 is prevented as much as possible. Therefore, the remaining bills 101 in the stacker 11 are prevented as much as possible from sequentially entering the end portion 3a of the bill transferring route 3 from their approximate centers.

As described above, the bill processing device 1 can prevent as much as possible a possibility that the bills 101 in the stacker 11 enter the end portion 3a of the bill transferring route 3, so that a bill 101 to be transferred next time to the end portion 3a of the bill transferring route 3 can be transferred to the end portion 3a with certainty, and a conventionally occurred jam of a bill can be prevented as much as possible.

If the bills 101 stored in the stacker 11 include a bill in poor condition such as a wrinkled bill or the like and the bills 101 as a whole in the stacker 11 become bulky, the both edge portions of the bill 101 in contact with the outer circumferential surface of the respective guide parts 4 are prevented as much as possible from a possibility of a slip on the outer circumferential surfaces of the respective guide parts 4 by high frictional force produced with an anti-slip member (a rubber member in this embodiment) which is the bill slip prevention means 9 disposed on the outer circumferential surface of the respective guide parts 4. Therefore, a possibility of entering the end portion 3a of the bill transferring route 3 from the approximate center of the bill 101 can be prevented as much as possible. Thus, the remaining bills 101 in the stacker 11 are prevented as much as possible from sequentially entering the end portion 3a of the bill transferring route 3 from their approximate centers.

Therefore, even if the bills 101 stored in the stacker 11 include a bill in a poor condition, the bill 101 to be transferred next time to the end portion 3a of the bill transferring route 3 can be transferred to the end portion 3a with certainty, and a conventional bill jam can be prevented as much as possible.

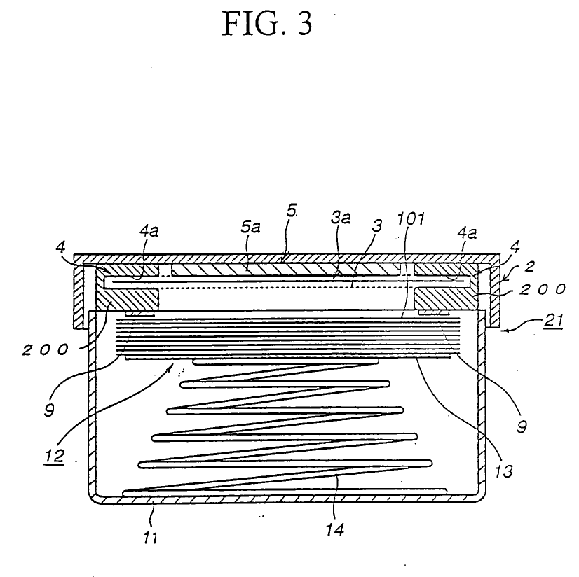

According to the bill processing device 1, the anti-slip member as the bill returning-back preventing means 9 is embedded in the respective outer circumferential surfaces of the pair of guide parts 4. The bill returning-back preventing means 9 may be satisfactorily disposed in the respective outer circumferential surfaces of the pair of guide parts 4. For example, the anti-slip member as the bill returning-back preventing means 9 may be adhered to the respective outer circumferential surfaces of the pair of guide parts 4 like the bill processing device 21 of a second embodiment of FIG. 3 where the same reference numerals are allotted to the same elements as those shown FIG. 1 and FIG. 2.

When the anti-slip member as the bill returning-back preventing means 9 is embedded in the respective outer circumferential surfaces of the pair of guide parts 4 like the bill processing device 1 of FIG. 1, the bills 101 stored in the stacker 11 can be stored in a flat state without being deformed.

In the above-described bill processing devices 1, 21, the pair of guide parts 4 are disposed in the device body 2. However, the pair of guide parts 4 configuring the bill processing device of the present invention are not limited to those disposed in the device body 2, but may be disposed in the stacker 11.

In the bill processing devices 1, 21, the pair of guide parts 4 is fixed to the device body 2. However, the pair of guide parts 4 configuring the bill processing device of the present invention is not limited to that configuration. For example, the pair of guide parts 4 may be configured of an operable member disposed within the device body 2.

Then, the bill processing device of a third embodiment of the present invention where the pair of guide parts 4 are configured of an operable member disposed within the device body 2 will be described.

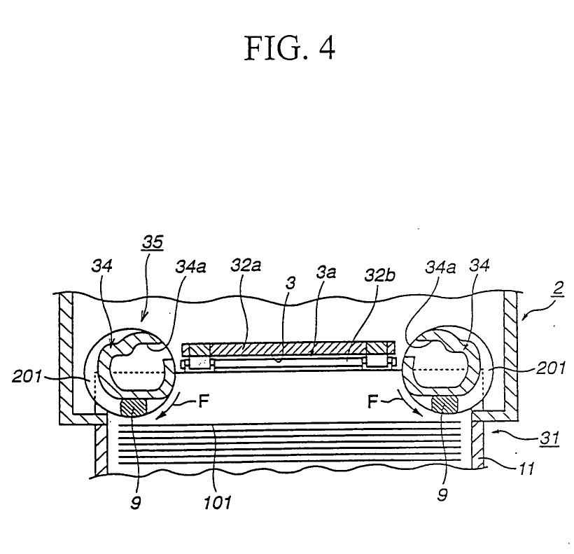

FIG. 4 is a schematic broken sectional view of the main part of the bill processing device of the third embodiment, which is a schematic diagram illustrating a state that plural bills are stored in the stacker. In FIG. 4, the same reference numerals are allotted to the same elements as those shown FIG. 1 to FIG. 3 and FIG. 5 to FIG. 12.

In a bill processing device 31 of the third embodiment shown in FIG. 4, a bill moving means 35 comprised of a pair of bill guide drums is disposed instead of the bill moving means 5 of the bill processing devices 1, 21 of the first and second embodiments.

The bill moving means 35 comprises a pair of guide parts 34 formed of guide members 201 which formed of a pair of bill guide drums disposed in the device body 2 and a guide part drive means (not shown) for driving the pair of guide parts 34.

The pair of guide parts 34 as the pair of bill guide drums are extended in a direction along the end portion 3a of the bill transferring route 3 configured of an upper shoot 32a and a lower shoot 32b, namely in a direction perpendicular to the sheet surface of FIG. 4, and a slit 34a where the edge portions on the lateral of the bill 101 are inserted is formed in the respective circumferential surfaces of the pair of guide parts 34. The slit 34a is also extended along a direction perpendicular to the sheet of FIG. 4.

In the bill processing device 31, when the bill 101 is guided to the end portion 3a of the bill transferring route 3, the both edge portions on the lateral of the bill 101 are inserted into the respective slits 34a of the pair of guide parts 34. When the pair of guide parts 34 in which the bill 101 is inserted rotate (in direction F of FIG. 4) in a direction to the outside of the device body 2 about a direction perpendicular to the sheet surface of FIG. 4 as an axis, the bill 101 inserted into the slits 34a is guided to the back sides of the pair of guide parts 34 by the bill guide drums 32 rotated, and the guided bill 101 is finally stored in the stacker 11.

For details of the operation of the bill moving means 35, refer to Japanese Patent Laid-Open Publications No. 2000-331216 and No. HEI 07-125896.

The both edge portions of the bill 101 stored in the stacker 11 are held between a stacker plate 14 and the respective outer circumferential surfaces of the pair of guide parts 34 by means of a stack spring (not shown). An anti-slip member (e.g., a rubber member) as the bill slip prevention means 9 is disposed in the respective outer circumferential surfaces of the respective guide parts 34 with which the both edge portions on the lateral of the bill 101, which is located on the side of the pair of guide parts 34, among the bills stored in the stacker 11 is contacted. This anti-slip member is disposed along the longitudinal direction of the bill 101 in the guide parts 34 with which the upper and lower parts of the both edge portions on the lateral of the bill 101 in the stacker 11 are contacted.

In the bill processing device 31 configured as described above, the both edge portions on the lateral of the bill 101, which is positioned on the side of the pair of guide parts 34, among the bills stored in the stacker 11 are contacted to the anti-slip members as the bill slip prevention means 9. Therefore, the both edge portions on the lateral of the bill 101 are prevented as much as possible from a possibility of a slip on the outer circumferential surfaces of the respective guide parts 34 by virtue of high frictional force produced between the mutually contacted bill 101 and anti-slip members (rubber members in this embodiment). Thus, a possibility of entering the end portion 3a of the bill transferring route 3 from the approximate center of the bill 101 is prevented as much as possible. Therefore, the remaining bills 101 in the stacker 11 are also prevented as much as possible from a possibility of entering the end portion 3a of the bill transferring route 3 from the respective approximate centers one after another. And, the conventionally occurred jam of a bill is prevented as much as possible.

Even if the bills 101 stored in the stacker 11 of the bill processing device 31 include bills in poor condition such as wrinkled bills and the like and the bills 101 as a whole in the stacker 11 become bulky, the both edge portions of the bill 101 in contact with the outer circumferential surfaces of the respective guide parts 34 are prevented from a possibility as much as possible of slipping on the outer circumferential surfaces of the respective guide parts 34 by high frictional force produced by the bill slip prevention means 9. Thus, the bills 101 in the stacker 11 are also prevented as much as possible from entering the end portion 3a of the bill transferring route 3 from their approximate centers. Therefore, according to the bill processing device 31 of the third embodiment, even if the bills 101 stored in the stacker 11 include a bill in poor condition, the bill 101 to be transferred next time to the end portion 3a of the bill transferring route 3 can be transferred to the end portion 3a with certainty, and the conventionally occurred jam of a bill can be prevented as much as possible.

The bill processing device 31 is configured to moved the bill 101 in the bill transferring route 3 to the back faces of the pair of guide parts 34 by rotating the bill guide drums as the pair of guide parts 34 toward the outside of the device body 2 about a direction perpendicular to the sheet surface of FIG. 4 as an axis. Therefore, when the bill 101 is moved by a rotational force of the guide parts 34, the bill 101, which is positioned on the side of the guide parts 34 and contacted with the guide parts 34, among the bills 101 stored in the stacker 11 also has its both edge portions on the lateral slidably contacted with the anti-slip members (rubber members in this embodiment) as the bill slip prevention means 9 and pulled to the outside on the lateral of the bill 101. Therefore, the bill 101 is further prevented as much as possible from entering the end portion 3a of the bill transferring route 3 by the anti-slip member in comparison with the first and second bill processing devices. Thus, the remaining bills 101 in the stacker 11 are also prevented as much as possible from a possibility of entering the end portion 3a of the bill transferring route 3 from the respective approximate centers. Therefore, a possibility of the conventionally occurred jam of a bill can be further prevented as much as possible.

The bill processing devices 1, 21, 31 of the first to third embodiments of the present invention were described assuming that a bill carrier roller or a carrier belt was not disposed within the slits 4a, 34a of the respective guide parts 4, 34. However, the bill processing device of the present invention is not limited to the described configurations of the slits 4a, 34a. For example, the bill carrier roller and the bill transferring belt may be disposed within the slits 4a, 34a of the respective guide parts 4, 34 of the bill processing device. Thus, the bill 101 inserted into the slits 4a, 34a may be facilitated so to be further transferred downstream of the bill transferring route 4.

In the above-described bill processing devices 1, 21, 31 of the first to third embodiments of the present invention, the bill moving means 5, 35 were determined to be disposed in the device body 2. However, the bill moving means 5, 35 configuring the bill processing device of the present invention are not limited to those disposed in the device body 2, but may be disposed in the stacker 11.

In the above-described bill processing devices 1, 21, 31, the anti-slip member as the bill slip prevention means 9 is disposed in the guide parts 4, with which the upper and lower parts of the both edge portions on the lateral of the bill 101 within the stacker 11 are contacted, along the longitudinal direction of the bill 101. However, the bill processing device of the present invention does not limit the anti-slip member to the described disposition position, but the slip prevention means 9 may be disposed in the guide parts 4, with which the entire longitudinal direction of the both edge portions on the lateral of the bill 101 in the stacker 11 is contacted, along the longitudinal direction of the bill 101.

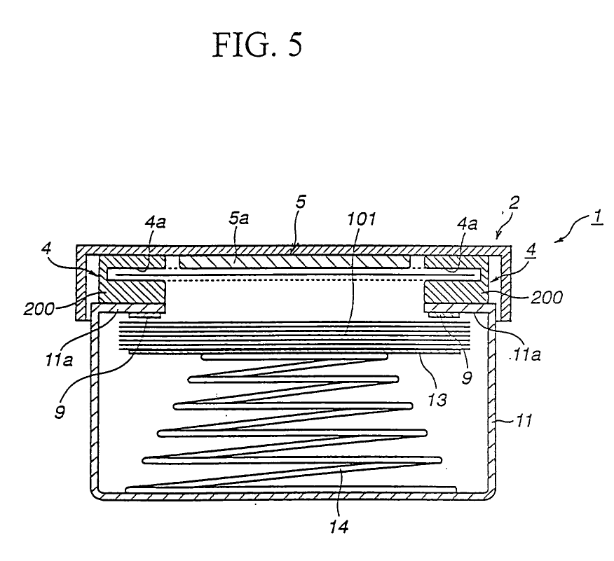

In the above embodiment, the guide parts 4 were described in detail referring to the case of forming of only the guide members 200 having the U-shaped cross section with the slit 4a formed. However, the present invention is not limited to the above-described embodiment. For example, the pair of guide parts 4 may be comprised of the guide members 200 having the U-shaped cross section with the slit 4a formed and an upper edge 11a of the stacker 11 having an L-shaped cross section and disposed on the outer circumferential surfaces of the members 200 as shown in FIG. 5 where the same reference numerals are allotted to the same elements as those shown FIG. 1. In this case, the bill slip prevention means 9 (e.g., a rubber member) may be disposed on the surface located on the side of the stacker 11 of the guide parts 4 comprised of the guide members 200 having the U-shaped cross section with the slit 4a formed and the upper edges 11a of the stacker 11 having an L-shaped cross section, namely the upper edges 11a having the L-shaped cross section.

Therefore, it is needless to say that the guide parts 4 include not only the members 200 having the U-shaped cross section with the slit 4a formed but also one integrally formed of the guide members 200 with the slit 4a formed and a portion of the other member configuring the bill processing device 1.

### INDUSTRIAL APPLICABILITY

As described above, the bill processing device according to the present invention is useful for vending machines, money changers, pinball dispensers, metal token dispensers and the like, as a bill processing device which prevents as much as possible a bill stored in the stacker from entering the bill transferring route to disturb the processing of a bill to be transferred next time.

1. A bill processing device comprising:
a pair of guide parts formed with a pair of slits into which both edge portions on the lateral of a bill guided by a bill transferring route are inserted along a longitudinal direction of the bill; and
a stacker that stores the bill which is inserted into the slits of the pair of guide parts and moved to back faces of the pair of the guide parts, wherein:
the respective guide parts are provided with bill slip prevention means at a portion thereof with which a bill which is positioned on the side of the pair of guide parts among the bills stored in the stacker is contacted, the bill slip prevention means preventing a slip of the edge portions on the lateral of the contacting bill, whereby the bills stored in the stacker are prevented from entering the bill transferring route by the bill slip prevention means.

2. The bill processing device according to claim 1, wherein the guide parts comprises respective guide members of a U-shaped cross section formed with the slit.

3. The bill processing device according to claim 1, wherein the guide parts comprises respective guide members of a U-shaped cross section formed with the slit and a part of the bill processing device to which the guide members are fixed.

4. The bill processing device according to claim 3, wherein the stacker has an L-shaped cross section, and a part of the bill processing device is an upper edge of the stacker.
